(19) United States
(12) Patent Application Publication
(10) Pub. No.: US 2006/0245884 A1
(43) Pub. Date: Nov. 2, 2006

(54) Systems and methods for lifting objects onto ATVs

(76) Inventor: George D. Allison, Warner Robins, GA (US)

Correspondence Address: PAPARELLA & ASSOCIATES, PLC, 930 N. WASHINGTON AVE., LANSING, MI, 48906, US

(21) Appl. No.: 11/103,856

(22) Filed: Apr. 12, 2005

(51) Int. Cl. B60P 1/00

(52) U.S. Cl. 414/543

(57) ABSTRACT

A method for lifting an object onto an ATV includes: rotating a component of a crank, wherein an object located near the ATV is lifted via an elongated flexible component responsive to the rotation of the component of the crank; rotating the object relative to a vertical axis not intersecting the object, wherein the object is positioned over the ATV responsive to the rotation of the object; and rotating the component of the crank, wherein the object is lowered onto the ATV responsive to the rotation of the component of the crank.

An all-terrain vehicle (ATV) typically comprises a small, open motor vehicle having one seat and three or more wheels (e.g., 4 wheels) fitted with relatively large tires, and designed chiefly for recreational use over road-less, rugged terrain. Examples of ATVs, among others, are the FourTrax™ and TRX™ models manufactured by Honda™. ATVs are often used by hunters who ride the ATVs to woods or forests where they hunt animals. Once a hunter hunts an animal, the animal may be manually loaded onto a load carrying device (e.g., metal basket) of the ATV (e.g., a person grabs the animal with both hands and lifts it onto the load carrying device). However, some animals may be too heavy to be carried onto the load carrying device of the ATV without risking injury to the person trying to carry the animal. Therefore there exists a need for systems and methods for addressing these and/or other problems associated with loading objects onto ATVs.

### SUMMARY

Systems and methods for lifting an object onto an ATV are provided. An embodiment of a system for lifting an object onto an ATV includes: an all-terrain vehicle (ATV), said ATV having at least three wheels configured to support the ATV and to contact terrain located below the ATV, and having at least one engine configured to provide torque to at least one of said at least three wheels; and a lift that is attached to a rear component of the ATV, said lift being configured to enable an object to be lifted from the terrain onto said ATV, said lift including: at least one crank; and an elongated flexible component that is in contact with the crank; and wherein said lift is configured to raise and lower said object via the elongated flexible component responsive to operation of the crank; and wherein said lift is configured to enable rotating said object around a vertical axis prior to said object being lifted onto said ATV, said vertical axis not intersecting said object while said object is rotating around said vertical axis.

An embodiment of a method for lifting an object onto an ATV includes: rotating a component of a crank, wherein an object located near the ATV is lifted via an elongated flexible component responsive to the rotation of the component of the crank; rotating the object relative to a vertical axis not intersecting the object, wherein the object is positioned over the ATV responsive to the rotation of the object; and rotating the component of the crank, wherein the object is lowered onto the ATV responsive to the rotation of the component of the crank.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1A is one embodiment of the lift system according to this invention.

FIG. 1B is another embodiment of the lift system according to this invention with the addition of support via a stabilization and a diagonal beam, and the addition of a locking mechanism on the load connector.

FIG. 2A is the lift system with stabilization via a stabilization shaft.

FIG. 2B is a rear-view of an embodiment of the lift system with two stabilization shafts.

FIGS. 3A-3G depict a non-limiting example of the lift system invention and its operation.

FIG. 4 depicts a non-limiting example of the connection system between the ATV and the lift system.

FIG. 5 depicts a non-limiting example of the lift system's connection to the base which allows for rotation of the lift system.

FIG. 6A depicts a front view of a non-limiting example of the plate used to connect the storage device on the ATV to the base on the lift system.

FIG. 6B depicts a side view of a non-limiting example of the plate used to connect the storage device on the ATV to the base on the lift system.

FIG. 6C depicts a front view of a non-limiting example the plate attached to the storage device on the ATV.

FIG. 6D depicts a side view of a non-limiting example the plate attached to the storage device on the ATV.

FIG. 6E depicts a side view of a non-limiting example of the stabilization beam configured between the vertical shaft on the lift system and the storage device on the ATV.

FIG. 6F depicts a top view of a non-limiting example of the stabilization beam between the vertical shaft on the lift system and the storage device on the ATV.

FIG. 7A depicts a front view of a non-limiting example of the stabilization shafts on the lift system in a disengaged position.

FIG. 7B depicts a side view of a non-limiting example of the stabilization shafts on the lift system in a disengaged position.

FIG. 7C depicts a front view of a non-limiting example of the stabilization shafts on the lift system in an engaged position.

FIG. 7D depicts a side view of a non-limiting example of the stabilization shafts on the lift system in an engaged position.

FIG. 8 depicts a non-limiting example of a crank and pulley system configured on the lift system.

FIGS. 9A and 9B depict respective views of an embodiment of vertical shafts used in the lift system shown in FIG. 1A.

FIGS. 10A and 10B depict respective views of an embodiment of upper shafts used in the lift system shown in FIG. 1A.

FIG. 11 depicts a non-limiting example of a sling that may be used in conjunction with lift system depicted in FIG. 1A.

FIG. 12 depicts a method to operate the lift system to engage the system, attach to a load, bring the load to its storage, and disengage.

### DETAILED DESCRIPTION OF THE PREFERRED EMBODIMENTS

As will be described in greater detail herein, an embodiment of the present invention comprises an all-terrain vehicle (ATV) and a lift system that is attached to the rear of the ATV. According to an embodiment of the invention, an ATV includes a lift system configured to lift objects onto the ATV. The lift system may be connected to an ATV via a hitch of the ATV. Part of the lift system is configured to rotate while the ATV remain substantially stationary. In one embodiment, the lift system is configured to lift a load located behind the ATV, and to then place the load onto a load carrying device of the ATV. The lift system may enable the load to be lifted via a crank and pulley combination.

Preferred embodiments of the invention will be described in more detail below with reference to the accompanying figures. Note that modifications to these embodiments may be made within the scope of the invention.

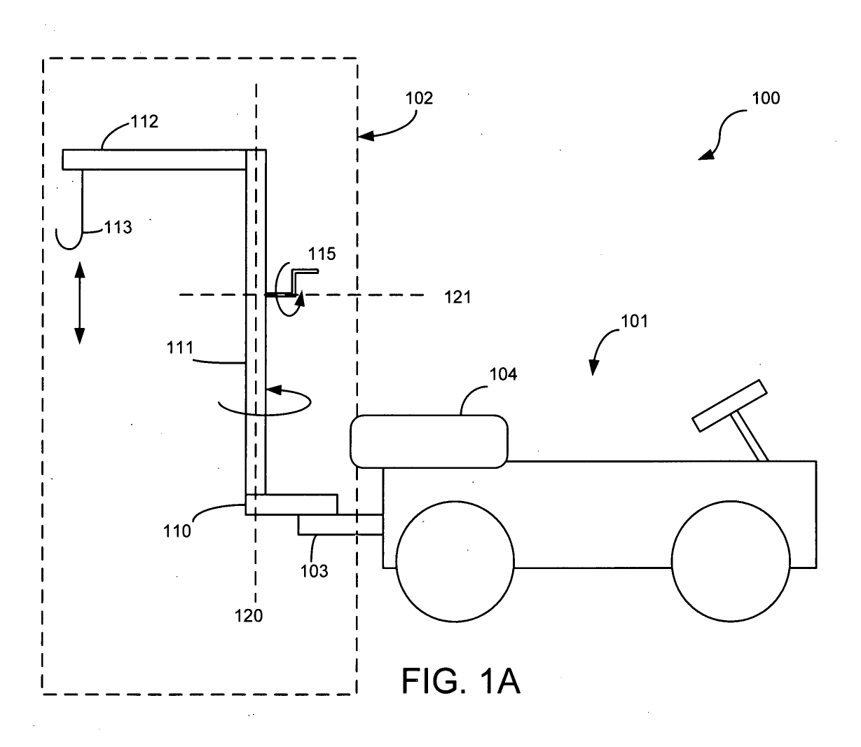

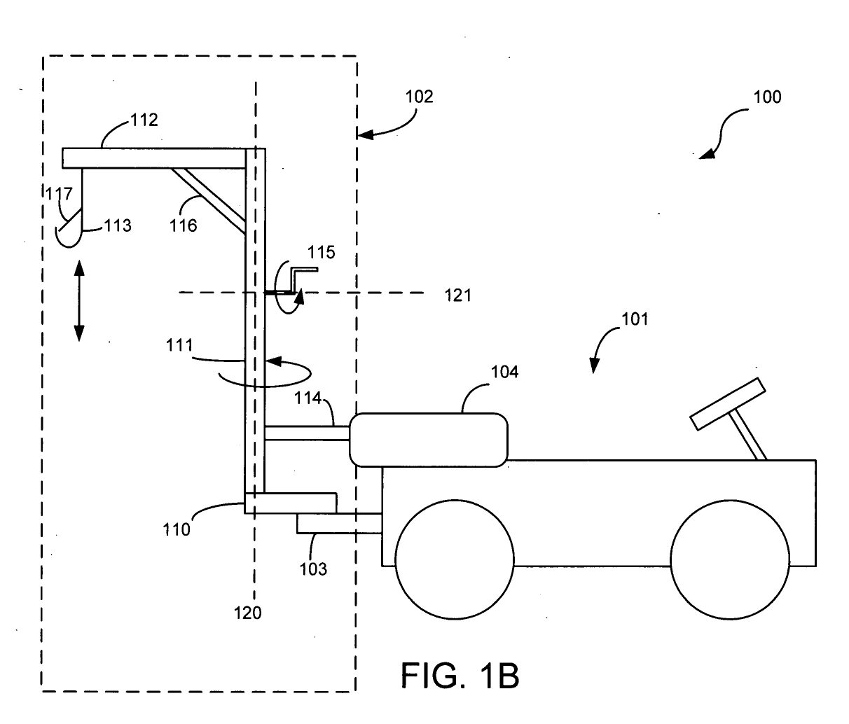

Referring now to the drawings, FIG. 1A depicts an embodiment of an ATV system 100 which includes an ATV 101 and a lift system 102. The ATV 101 is an all-terrain vehicle (ATV) which includes a load carrying device 104 and a hitch 103 to connect external devices to the ATV 101 such as the lift system 102.

The lift system 102 is configured to lift a load to the ATV 101 and may be attached to the hitch 103 via a base 110. The lift system 102 may comprise, for example a metal or a metal alloy including, for example, iron or aluminum. Components of the lift system 102 may be connected together via, for example, soldering and/or nut and bolt connections.

The lift system 102 includes a base 110 that is connected to a vertical shaft 111. The vertical shaft 111 rotates along an axis 120 to allow a portion of the lift system 102 to rotate for the purpose of positioning such portion of the lift system 102 above a load that is to be loaded onto the ATV 101. A crank 115, which attaches to the vertical shaft 111, is operated by having its handle turned around an axis 121. An upper shaft 112 connects on the top of the vertical shaft 111 and also rotates along with the vertical shaft 111 on axis 120. A load connector 113 is supported by the upper shaft 112 and is connected to the crank 115 to allow the load connector 113 to move up and down with the rotation of a handle of the crank 115.

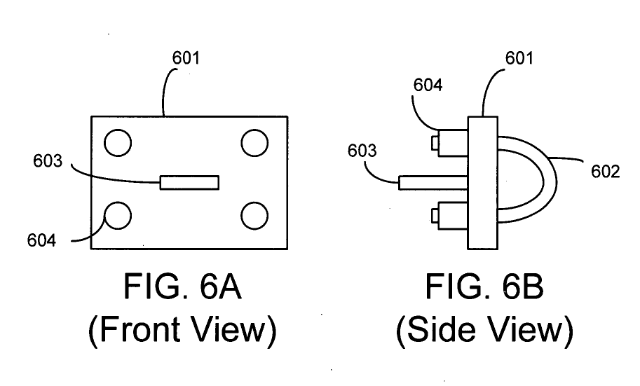

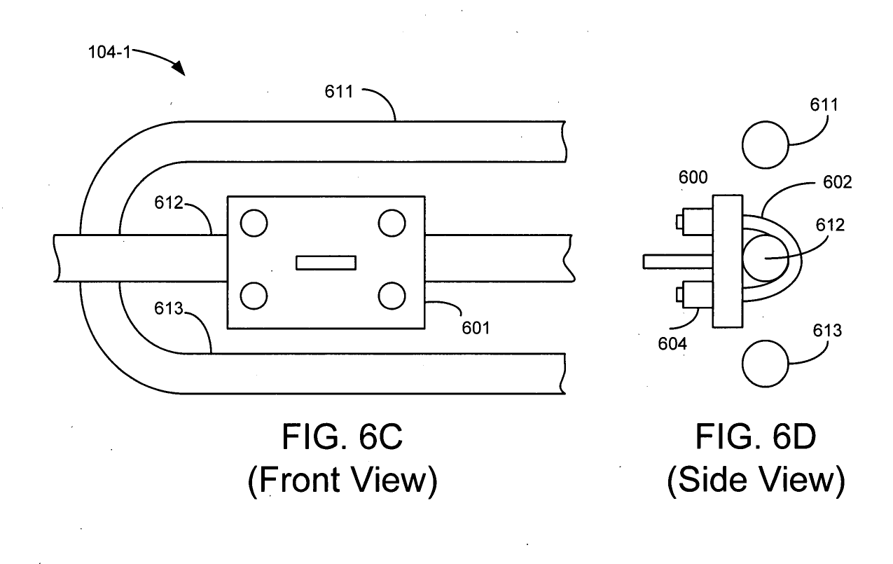

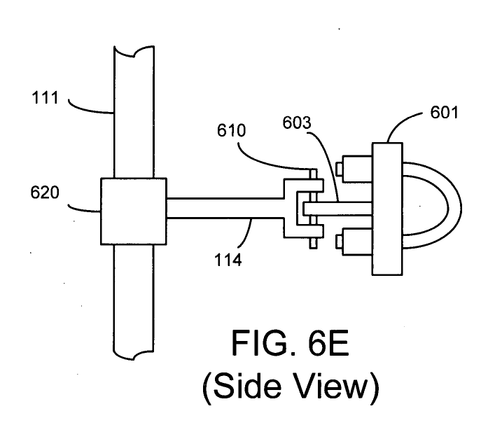

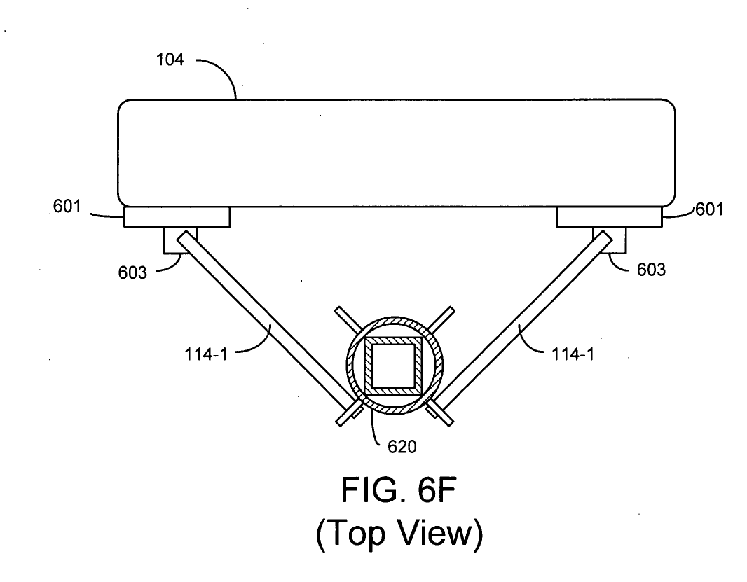

FIG. 1B depicts another embodiment of the ATV system 100 with the addition of a support shaft between the ATV 101 and the lift system 102, and a support shaft between the vertical shaft 111 and the upper shaft 112. These additional support shafts enable the lift system 102 to engage heavier loads. A stabilization beam 114 attaches to the vertical shaft 111 (e.g., through a ring connector—FIG. 6E and 6F) and to the load carrying device 104 (e.g., via welding or a nut and bolt connection) to provide for additional support. A diagonal beam 116 is connected (e.g., welded) between the upper shaft 112 and the vertical shaft 111. Also, a locking mechanism 117 may be incorporated into the load connector 113 to secure a load attached to the ATV system 100.

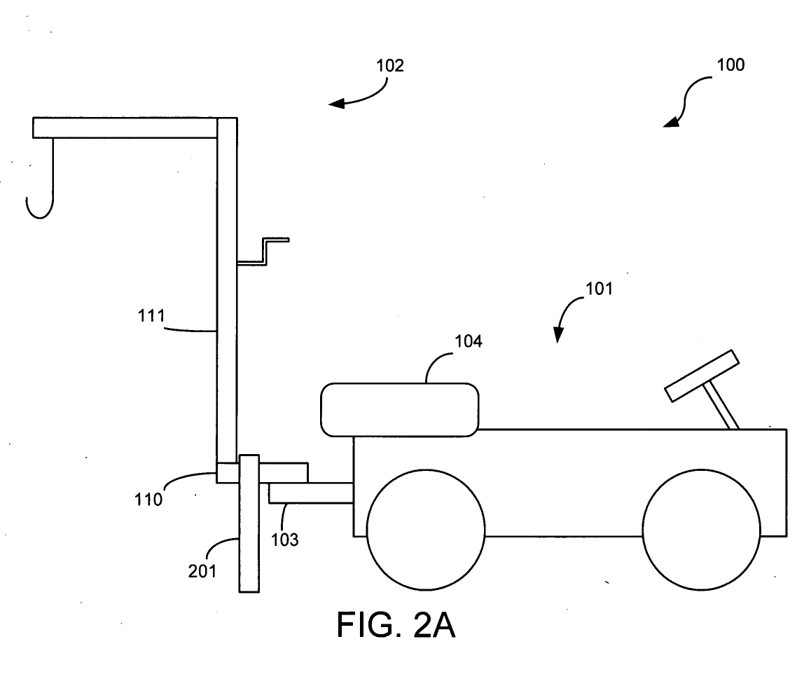

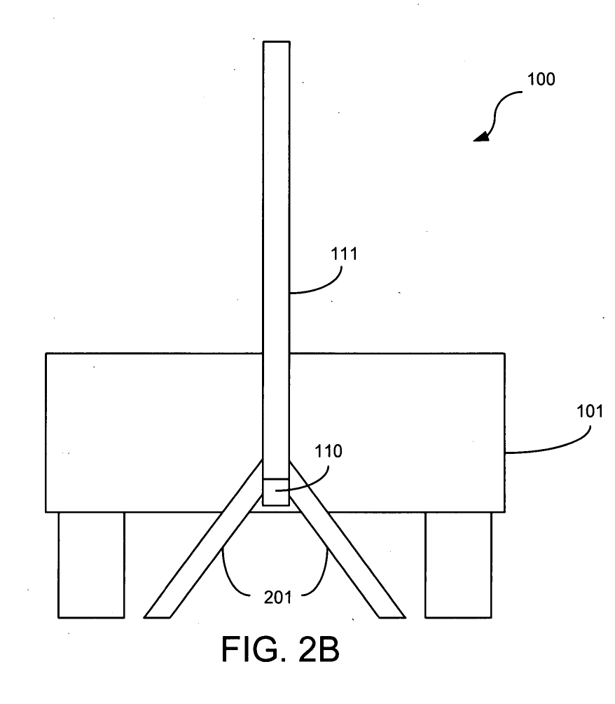

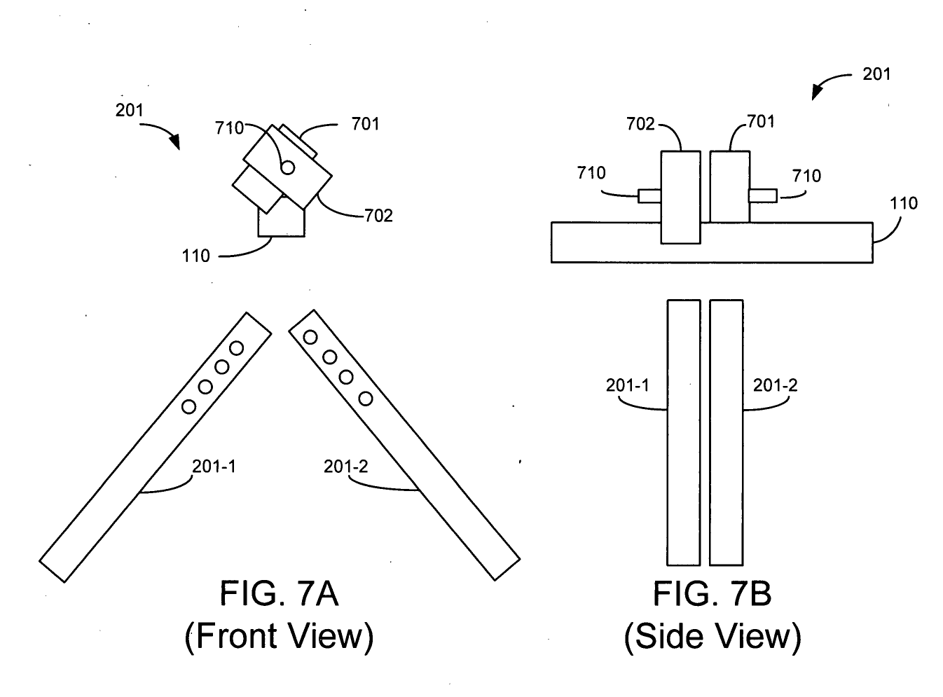

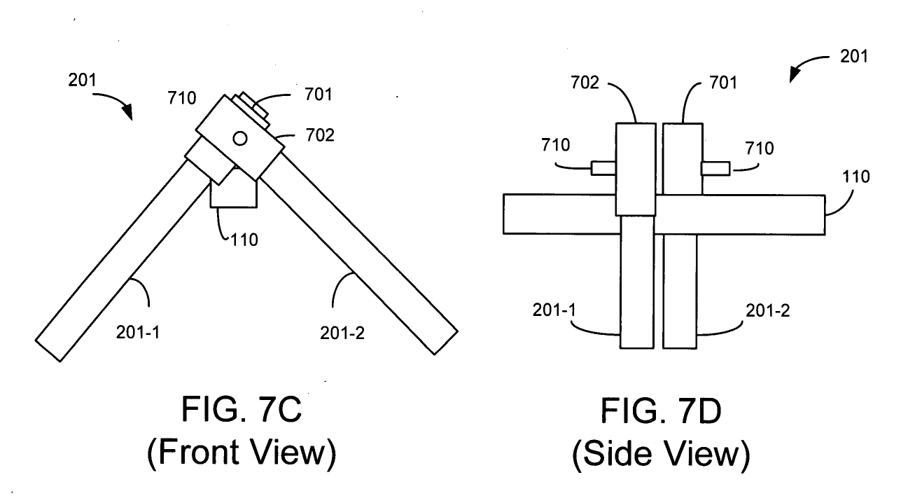

FIG. 2A depicts stabilization shaft(s) 201 configured to provide stabilization and support to the ATV system 100. The ATV system 100 may include one or more stabilization shaft(s) 201. The stabilization shaft(s) 201 connects to the lift system 102 via the base 110 (e.g., via welding or a detachable connection). The stabilization shaft(s) 201 is engaged when the ATV 101 is stationary and ready to lift the load. FIGS. 2B, 7A, 7B, 7C, and 7D depict a non-limiting example of two stabilization shafts.

FIG. 2B depicts a rear view profile of the stabilization shaft(s) 201 configured in this example with two beams in an engaged position. The two stabilization shafts 201 are connected to the base 110 (e.g., via a nut and bolt connection) and are configured to extend outwards diagonally to the ground.

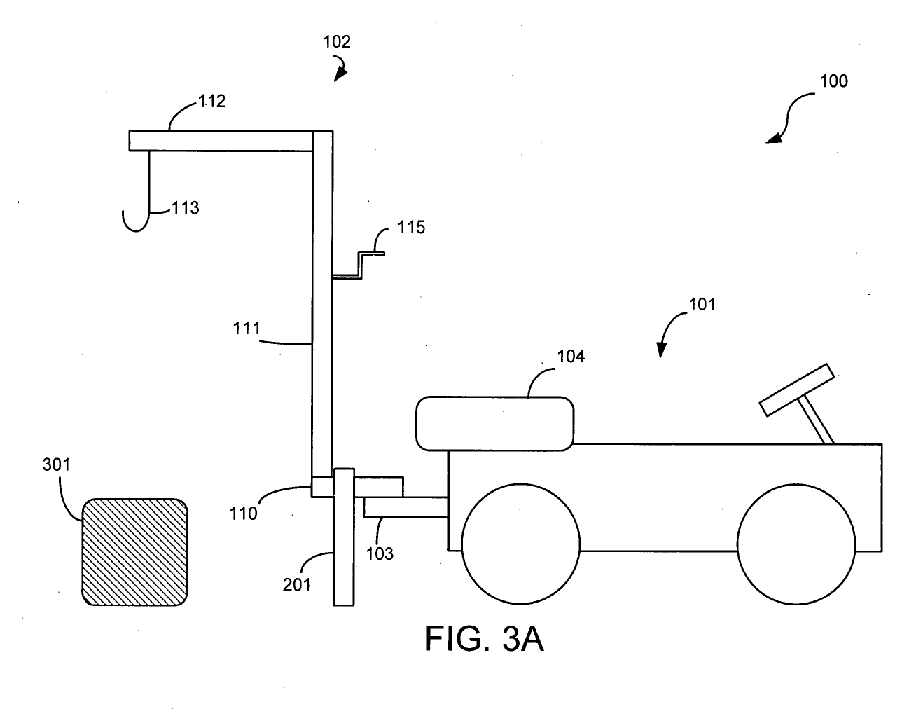

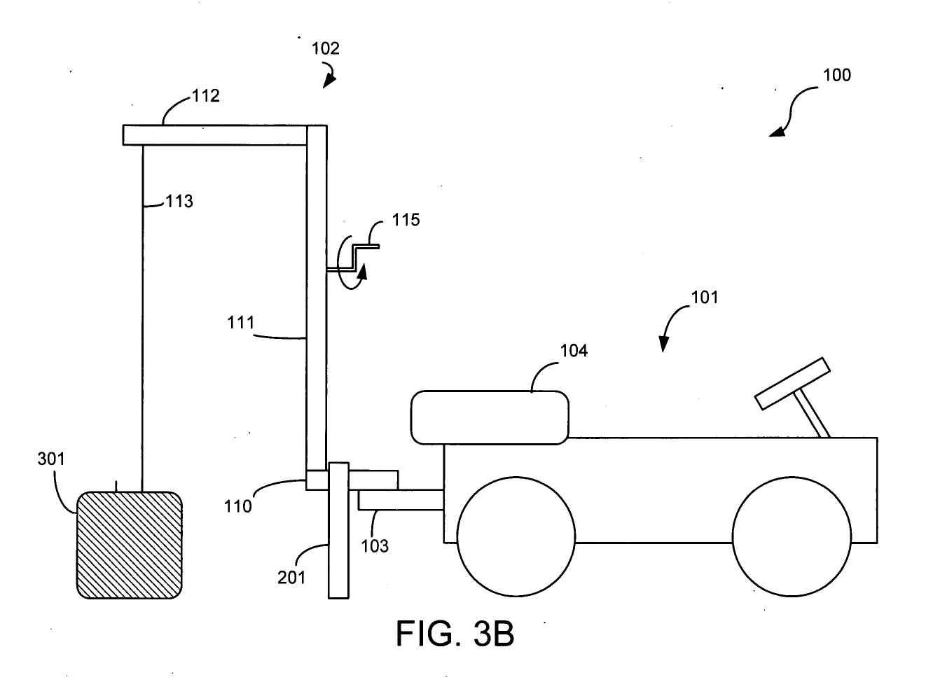

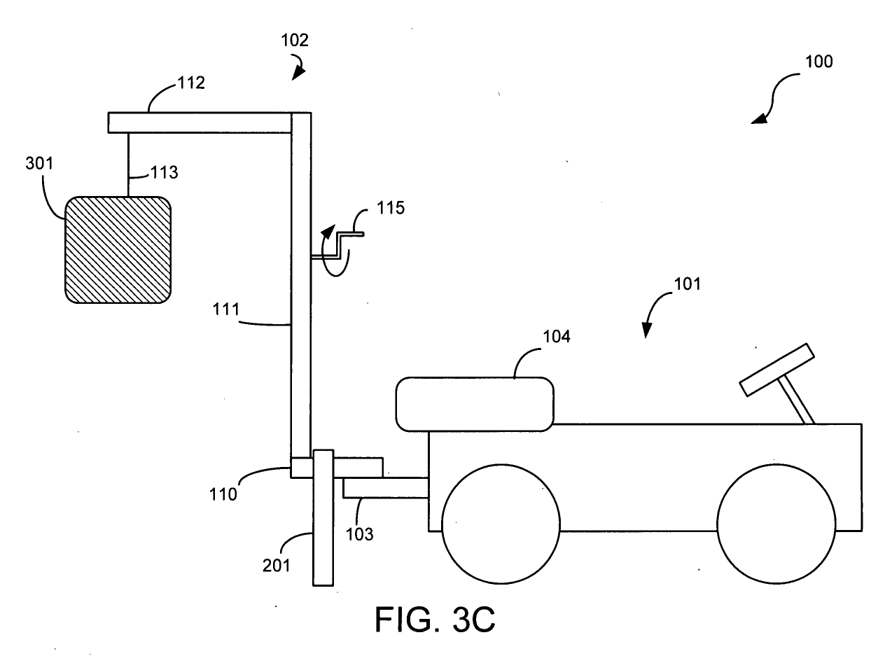

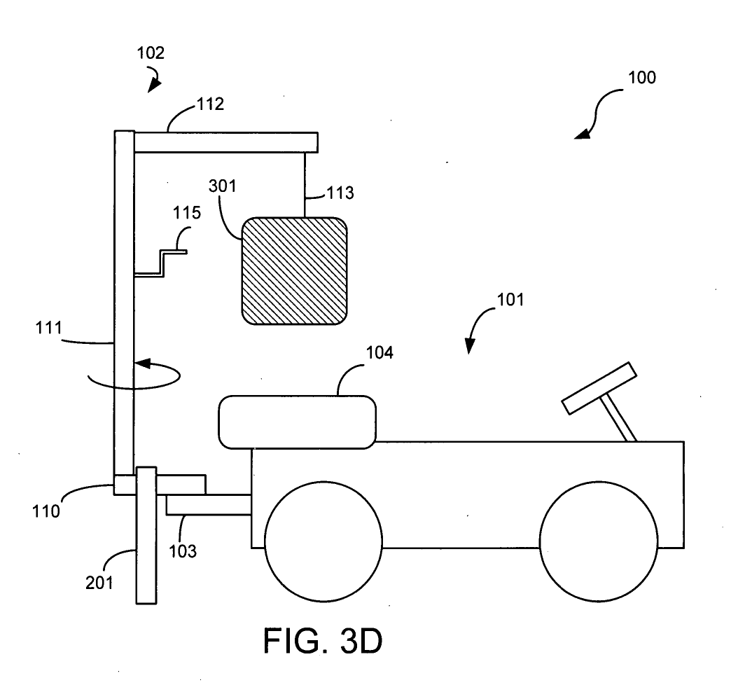

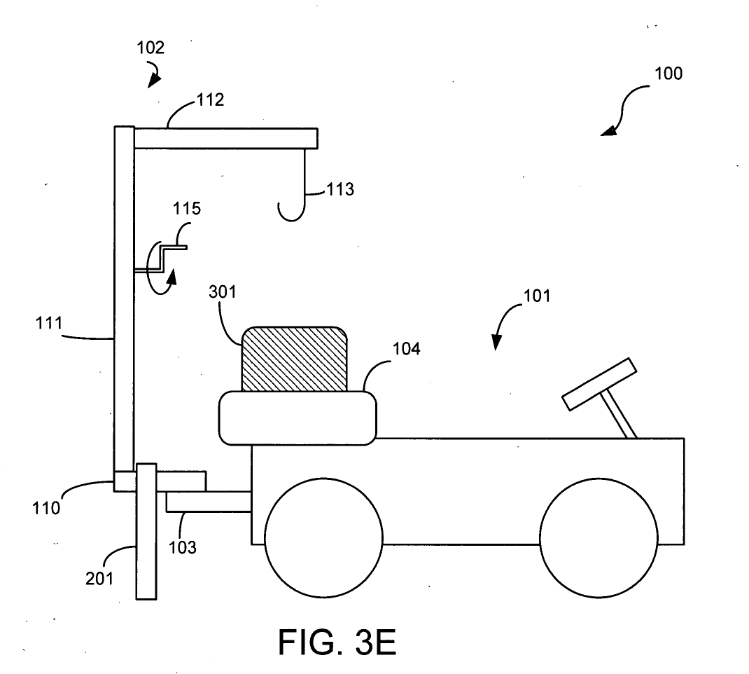

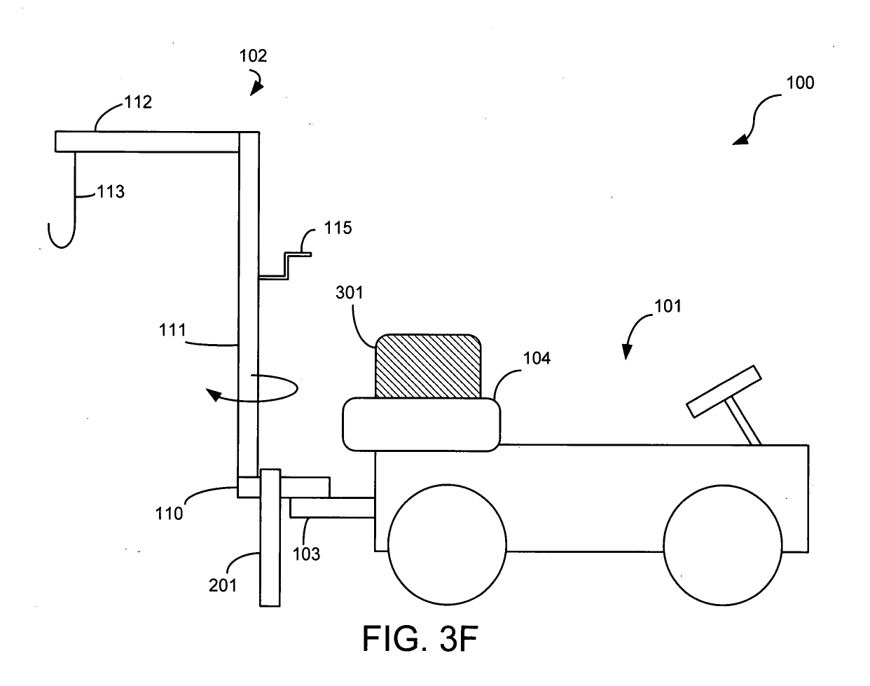

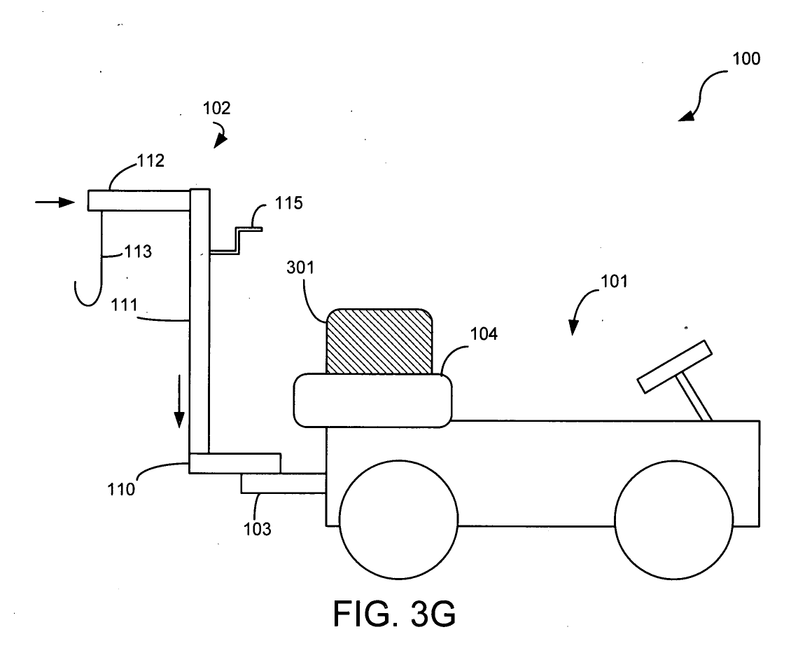

FIGS. 3A through 3G depict a non-limiting example of the operation of the ATV system 100. FIG. 3A depicts a load 301 to be lifted with the ATV system 100. In this example, the ATV system 100 is stationary next to the load 301 and the stabilization shafts 201 are engaged.

FIG. 3B depicts a lowering of the load connector 113 to the load 301 by rotating a handle of the crank 115 about axis 121. The load connector 113 is attached (directly or indirectly) to the load 301. The load connector 113 may be indirectly attached to the load 301 via a harness (not shown).

FIG. 3C depicts a lifting of the load 301 attached to the load connector 113 by rotating a handle of the crank 115 about axis 121 (e.g., in an opposite direction as that used to lower the load connector 113).

FIG. 3D depicts a movement of the load 301 into position over the load carrying device 104 by rotating the upper shaft 112 about axis 120.

FIG. 3E depicts lowering of the load 301 into the load carrying device 104 on the ATV 101 by rotating the crank 115 about axis 121.

FIG. 3F depicts rotating the upper shaft 112 back towards the rear (e.g., by rotating it 180 degrees along axis 120).

FIG. 3G depicts retracting the upper shaft 112 and the vertical shaft 111 to enable operation of the ATV 101 with the lift system 102 attached to the hitch 103.

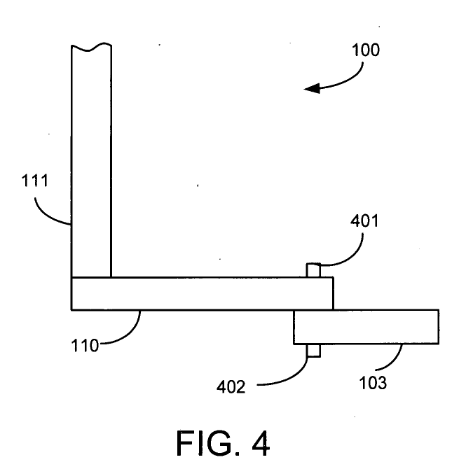

FIG. 4 depicts a non-limiting example of means for connecting the lift system 102 to the ATV 101. The base 110 of the lift system 102 is attached to the hitch 103 of the ATV 102 via a nut 401 and a bolt 402.

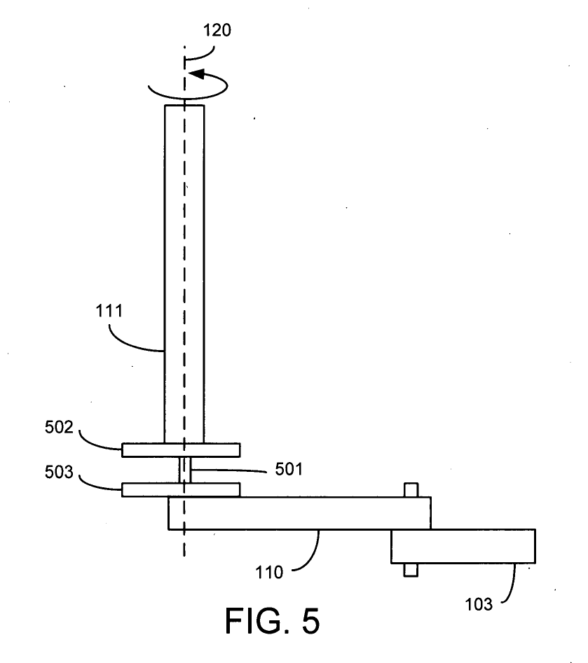

FIG. 5 depicts a non-limiting example of means of connecting the base 110 to the vertical shaft 111 in such a manner to allow rotation of the vertical shaft 111 about axis 120. A pin 501 is attached to a plate 503 (e.g., welded) and the pin 501 fits inside the vertical shaft 111. The vertical shaft 111 is attached to a plate 502 (e.g., welded) and the plate 502 contains a hole to allow the pin 501 to fit inside. The base 110 is attached to a plate 503 (e.g., welded). The plate 502 makes contact with the plate 503 during operation of the lift system 102.

FIG. 6A depicts a front view of a non-limiting example of a plate 601 configured to connect the stabilization beam 114 to the load carrying device 104. The plate 601 is shown as a rectangular plate with four holes. A plate connector 603 extends out from the center of the plate 601 and contains a hole to allow for a nut and bolt connection from the stabilization beam 114.

FIG. 6B depicts a side view of a non-limiting example of a plate 601 configured to connect the stabilization beam 114 to the load carrying device 104. The plate 601 is shown with the plate connector 603 configured in the middle of the plate 601. A bolt 602 connects to the holes in the plate 601 and is attached to the plate 601 by the nuts 604. In this particular example, two circular bolts 602 are connected around the railing of the load carrying device 104 and into the holes of the plate 601 and finally are connected with the nuts 604.

FIG. 6C depicts a front view of a non-limiting example of the connection of the plate 601 to the load carrying device 104-1. The load carrying device 104-1 is shown in this example with an upper bar 611, a middle bar 612, and a lower bar 613. The plate 601 is configured by attaching it to the middle bar 613 (e.g., nut and bolt).

FIG. 6D depicts a side view of a non-limiting example of the connection of the plate 601 to the load carrying device 104-1. The plate 601 attaches to the middle bar 613 of the load carrying device 104-1 via the bolt 602 and the nut 604.

FIG. 6E depicts a non-limiting example of the stabilization beam 114 configured to connect between the vertical shaft 111 and the load carrying device 104. A ring 620 attaches around the vertical shaft 111 and the ring 620 connects to the stabilization beam 114 (e.g., flange connector via nut and bolt). The ring 620 fits over the vertical shaft 111 to allow the vertical shaft 111 to rotate about axis 120 while the ring 620 remains stationary. On the other end, the stabilization beam 114 is configured to connect to load carrying device 104 via a bolt 610.

FIG. 6F depicts a top-view of a non-limiting example of two horizontal stabilization beams 114 configured to connect between the load carrying device 104 and the vertical shaft 111. In this example, each of the stabilization beams 114 is configured to attach directly to the ring 620 (e.g., screw into the flange)

FIG. 7A depicts a front view of a non-limiting example of two stabilization shafts 201 in a disengaged position. A stabilization shaft connector 701 and 702 attach to the base 110 (e.g., welded). Each of the stabilization shaft connectors 701 and 702 are hollow to allow for insertion of the stabilization shaft(s) 201 and contain a pin hole to support the insertion of a pin 710 to lock the stabilization shaft(s) 201 when engaged. Two example stabilization shafts 201-1 and 201-2 are shown configured with four holes to allow for the stabilization shafts 201-1 and 201-2 to be lowered or raised either when engaging or disengaging the ATV system 100.

FIG. 7B depicts a side view of a non-limiting example of two stabilization shafts 201-1 and 201-2 in a disengaged position. The stabilization shaft connectors 701 and 702 are attached (e.g., welded) to the base 110 on opposite sides.

FIG. 7C depicts a front view of a non-limiting example of two stabilization shafts 201-1 and 201-2 in an engaged position. Each of the stabilization shafts 201-1 and 201-2 are inserted into the stabilization shaft connectors 701 and 702. The pin 710 is inserted to lock the stabilization shafts 201-1 and 201-2 in place.

FIG. 7D depicts a side view of a non-limiting example of two stabilization shafts 201-1 and 201-2 in an engaged position. The pin 710 is shown configured in both the stabilization shaft connectors 701 and 702, locking the two stabilization shafts 201-1 and 201-2 in place.

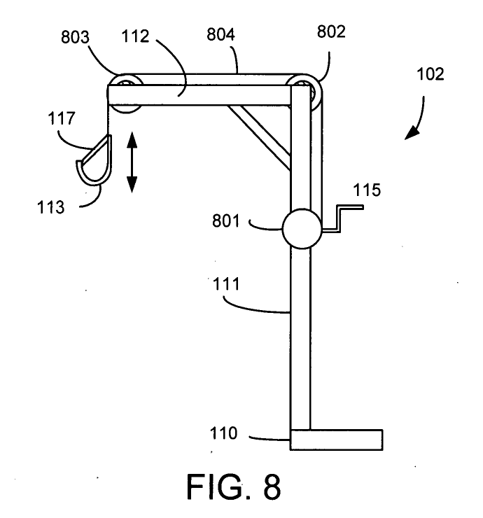

FIG. 8 depicts a non-limiting example of pulleys 802 and 803 attached to the lift system 102. A crank base 801 is attached to the vertical shaft 111 and includes the crank 115. A link 804 (e.g., rope or chain) is routed via the pulleys 802 and 803 between the crank 115 and the load connector 113. Rotating a handle of the crank 115 moves the link 804 (e.g., rope or chain) along the pulleys 802 and 803 to allow lowering or raising of the load connector 113. The load connector 113 may be, for example, a clasp that includes a locking mechanism 117.

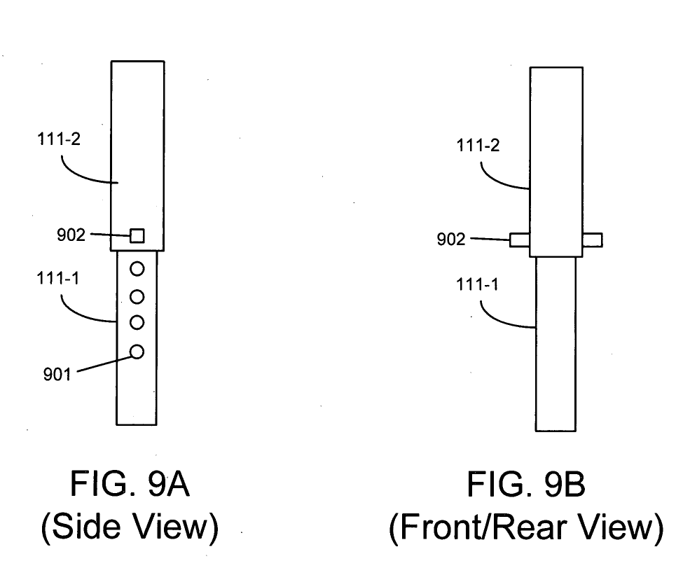

FIGS. 9A and 9B depict respective views of an embodiment of vertical shafts 111 used in the lift system 102 (FIG. 1A). As shown in FIG. 9, the lift system 102 includes two vertical shafts 111 (vertical shafts 111-1 and 111-2). The vertical shaft 111-1 is configured to fit at least partially within the vertical shaft 111-2. The vertical shaft 111-1 and the vertical shaft 111-2 have holes 901 that accommodate a pin 902. The height of the lift system 102 may be adjusted by removing the pin 902, sliding the shaft 111-2 up or down, and then reinserting the pin 902 into a set of holes 901 corresponding to a desired height.

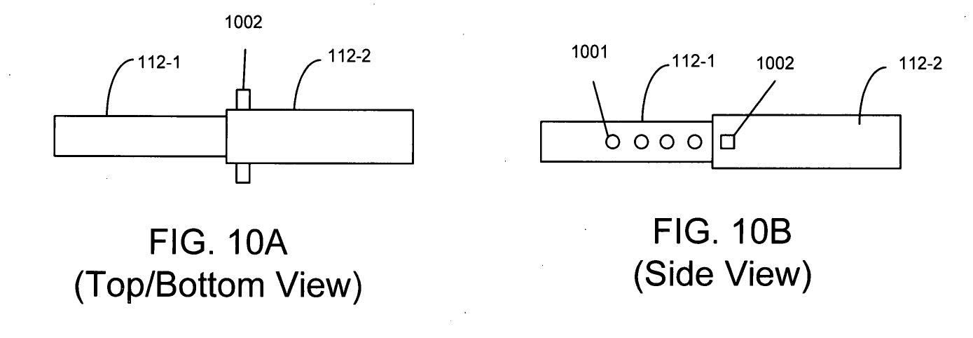

FIGS. 10A and 10B depict respective views of an embodiment of upper shafts 112 used in the lift system 102 (FIG. 1A). As shown in FIG. 10, the lift system 102 includes two upper shafts 112 (upper shafts 112-1 and 112-2). The upper shaft 112-1 is configured to fit at least partially within the upper shaft 112-2. The upper shaft 112-1 and the upper shaft 112-2 have holes 1001 that accommodate a pin 1002. The width of the lift system 102 may be adjusted by removing the pin 1002, sliding the shaft 112-1 sideways, and then reinserting the pin 1002 into a set of holes 1001 corresponding to a desired width.

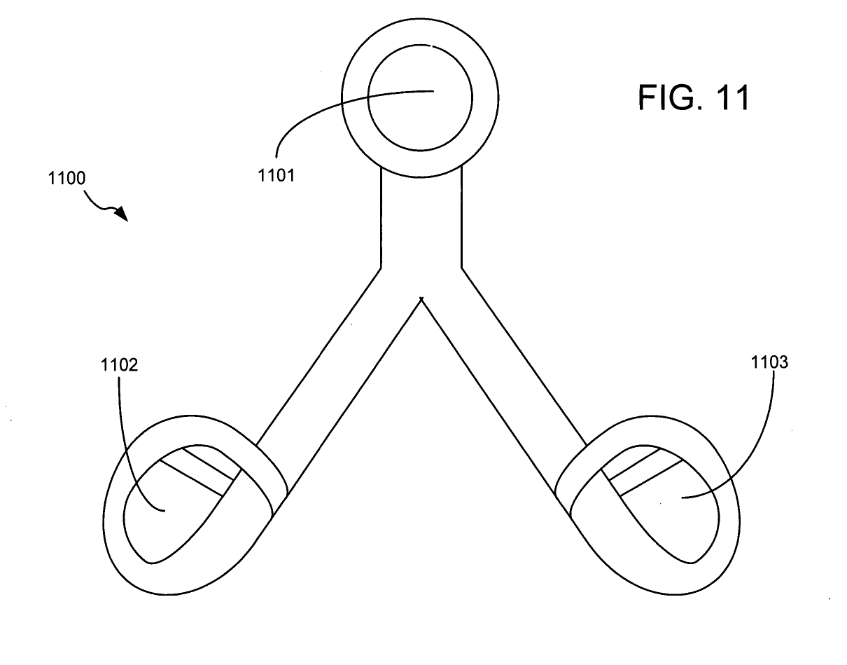

FIG. 11 depicts a non-limiting example of a sling 1100 that may be used in conjunction with lift system 102 (FIG. 1A). The sling 1100, may comprise any suitable flexible material or combination of materials such as, for example, nylon, plastic, rubber, among others. The sling 1100 includes an opening 1101 that may be used to enable the sling 1100 to be connected to the link 804 (FIG. 8) (e.g., via the load connector 113), as well as openings 1102 and 1103 that may be used to enable the sling to be connected to respective legs of an animal that is to be loaded onto the load carrying device 104. The openings 1102 and 1103 are configured to tighten as force is exerted on the sling by objects in the openings 1102 and 1103.

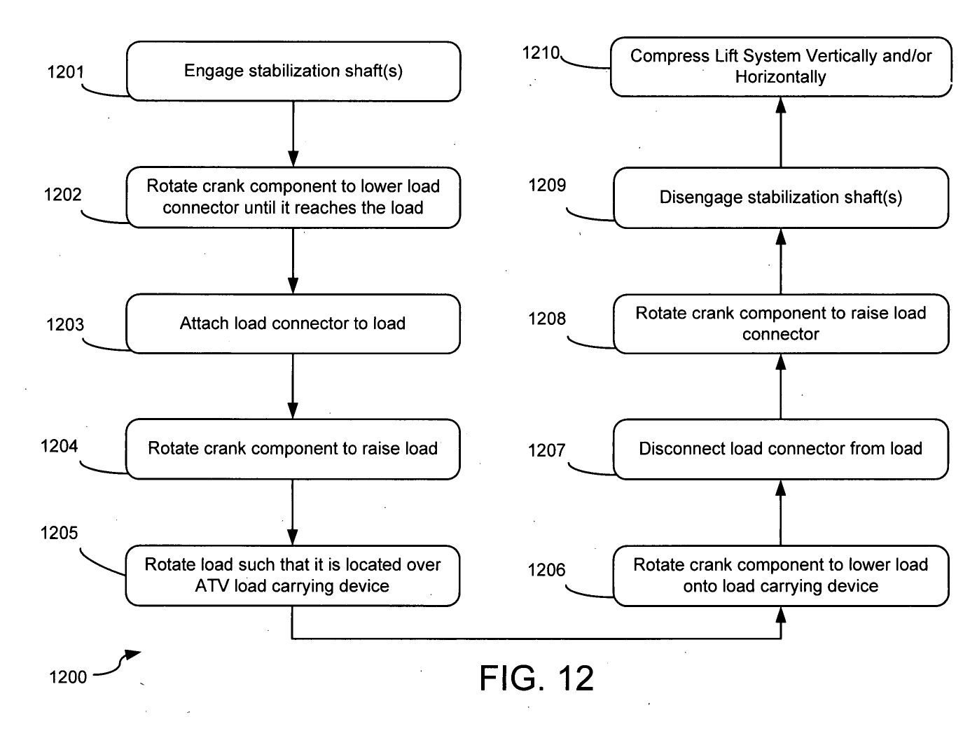

FIG. 12 depicts a method 1200 for operating the ATV system 120. The method 1200 includes: engaging a stabilization shaft(s) on a lift system to provide for ground support (step 1201), rotating a component of a crank (e.g., a handle in the case of a manually operated crank) to lower a load connector until it reaches a load located near the rear of the ATV system 120 (step 1202), attaching a load connector (e.g., a sling, a clasp, a clip, or a hook) to a load (step 1203), rotating the component of the crank to raise the load (step 1204), rotating the load while it is attached to the load connector such that it is subsequently located over a load carrying device of the ATV system (step 1205), rotating the component of the crank to lower the load onto the load carrying component (step 1206), disconnecting the load connector from the load (step 1207), rotating the component of the crank to raise the load connector (step 1208), disengaging the stabilization shaft(s) (step 1209), and (optionally) compressing the lift system vertically and/or horizontally (step 1210) (e.g., reducing the height and/or width of the lift system).

It should be emphasized that the above-described embodiments of the present invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and present invention.

What is claimed is:

1. A system comprising:
an all-terrain vehicle (ATV), said ATV having at least three wheels configured to support the ATV and to contact terrain located below the ATV, and having at least one engine configured to provide torque to at least one of said at least three wheels; and
a lift that is attached to a rear component of the ATV, said lift being configured to enable an object to be lifted from the terrain onto said ATV, said lift including:
at least one crank; and
an elongated flexible component that is in contact with the crank; and
wherein said lift is configured to raise and lower said object via the elongated flexible component responsive to operation of the crank; and
wherein said lift is configured to enable rotating said object around a vertical axis prior to said object being lifted onto said ATV, said vertical axis not intersecting said object while said object is rotating around said vertical axis.

2. The system of claim 10, wherein the lift further comprises:
at least one stabilization shaft that is attached to said lift, said stabilization shaft being configured to prevent the ATV from tipping over while said object is being loaded onto the ATV via the lift.

3. The system of claim 1, wherein the crank is configured to be operated manually.

4. The system of claim 1, wherein the crank is configured to be operated via an electric motor.

5. The system of claim 1, wherein the crank comprises a handle configured to activate the crank.

6. The system of claim 1, wherein the elongated flexible component comprises a rope.

7. The system of claim 1, wherein the elongated flexible component comprises a chain.

8. The system of claim 1, further comprising a pulley, wherein the elongated flexible component is in contact with said pulley while said object is being loaded onto said ATV.

9. The system of claim 8, wherein said pulley is configured to rotate responsive to activation of the crank.

10. The system of claim 1, wherein the lift further comprises:
a first substantially vertical shaft that is configured to rotate around said vertical axis, said first substantially vertical shaft being configured to support a weight of the object while said object is being loaded onto said ATV; and
a first substantially horizontal shaft that is configured to rotate around said vertical axis, said first substantially horizontal shaft being connected to said first substantially vertical shaft.

11. The system of claim 10, further comprising a second substantially vertical shaft that is located at least in part inside said first substantially vertical shaft, wherein a height of the lift is responsive to an extent to which said second substantially vertical shaft is located inside said first substantially vertical shaft.

12. The system of claim 10, further comprising a second substantially horizontal shaft that is located at least in part inside said first substantially horizontal shaft, wherein a width of the lift is responsive to an extent to which said second substantially horizontal shaft is located inside said first substantially horizontal shaft.

13. A method implemented via an all-terrain vehicle (ATV) and a lift that is attached to a rear component of the ATV, said ATV having at least three wheels configured to support the ATV and configured to contact terrain located below the ATV, and having at least one engine configured to provide torque to at least one of said at least three wheels, said lift including a crank and an elongated flexible component that is connected to said crank, said method comprising:
rotating a component of the crank, wherein an object located near the ATV is lifted via the elongated flexible component responsive to the rotation of the component of the crank;
rotating the object relative to a vertical axis not intersecting the object, wherein the object is positioned over the ATV responsive to the rotation of the object; and
rotating the component of the crank, wherein the object is lowered onto the ATV responsive to the rotation of the component of the crank.

14. The method of claim 13, further comprising:
causing a stabilization shaft that is attached to the lift to come in contact with the terrain, said stabilization shaft being configured to prevent the ATV from tipping over while said object is being loaded onto the ATV via the lift.
